(19) United States
(12) Patent Application Publication
(10) Pub. No.: US 2006/0003111 A1
(43) Pub. Date: Jan. 5, 2006

(54) System and method for creating a 3D figurine using 2D and 3D image capture

(76) Inventor: Tan Tseng, Redwood City, CA (US)

Correspondence Address: Tan Tseng, 525 Breakwater Dr., Redwood City, CA, 94065, US

(21) Appl. No.: 10/966,681

(22) Filed: Oct. 14, 2004

Related U.S. Application Data
(60) Provisional application No. 60/584,597, filed on Jul. 1, 2004.

(51) Int. Cl. A01N 1/00

(52) U.S. Cl. 428/16; 428/195.1

(57) ABSTRACT

A method of making a three dimensional head representative of a head of a three dimensional object includes the steps of creating a geometric file of the head of the three dimensional object, creating an image file of the head of the three dimensional object, milling a milled head based upon the geometric file, recasting the milled head into a sculptable head, sculpting the sculptable shape, painting features onto the sculpted shape based upon the image file.

### CROSS REFERENCE TO RELATED APPLICATIONS

The present application claims priority under 35 U.S.C. 119(e) from provisional patent application Ser. No. 60/584,597, entitled “Custom 3-D Figurine Created from a 3-D Camera”, filed on Jul. 1, 2004, the disclosure of which is herein incorporated by reference in its entirety.

### BACKGROUND OF THE INVENTION

The present invention relates to three dimensional (3D) object capture, and more particularly to capturing two dimensional (2D) and 3D images and fitting 2D details onto a 3D object.

It is well known in the art to capture images of people and other 3D objects using traditional cameras. More recently, digital cameras have been used to capture 2D images of 3D objects. The captured digital images may be stored for later viewing and printing. Such images allow for impressive detail and color.

FIGS. 1A and 1B show a digital camera 12 operable to capture a 2D image and a computer 14 and printer 16 for displaying the 2D image. In FIG. 1A, digital camera 12 has a lens that captures light from a 3D object 10. The light collected from object 10 may be sent to a charge-coupled-device (CCD) or other image sensor within digital camera 12. The 2D surface of the CCD converts the captured light to pixels that represent color and shades at different ordinate positions on the surface of the CCD. The pixels generated by digital camera 12 may be stored in a standard format, such as the Joint-Pictures-Experts-Group (JPEG) or bit map format (BMP). The pixels may be in a pattern such as a Bayer pattern where some x and y positions may have pixels of some colors but not other colors, requiring interpolation to generate the missing colors.

With reference to FIG. 1B, computer 14 may receive a JPEG image file from digital camera 12. A memory card from digital camera 12 can be inserted into a special reader on computer 14, or an interface such as a Universal-Serial-Bus (USB) cable may be used to transfer the digital image file to computer 14. The digital image represented by the JPEG file may be converted to display pixels and displayed by computer 14, or may be converted to printable pixels and printed by printer 16. Printer 16 can output a 2D picture 18 of 3D object 10. While colorful and detailed, 2D picture 18 is still a flat image and thus is not a perfect representation of 3D object 10 as it lacks the third dimension.

FIGS. 2A and 2B show a 3D cameras 20 and 20′ and a 3D milling machine 24 operable to generate a 3D replica. In FIG. 2A, 3D camera 20 may capture a 3D image of 3D object 10. A variety of technologies can be used by 3D camera 20 to capture not only the 2D image, but also 3D information of object 10. For example, some 3D cameras may have a mechanical probe that touches the surface of 3D object 10. As the probe slides along the surface of 3D object 10, 3D camera 20 records movements of the probe that correspond to 3D features of object 10.

Other implementations may use a laser range-finder to determine distances from 3D camera 20 to locations on the surface of 3D object 10. The range-finder may be scanned across the surfaces of 3D object 10. Another method is to project a grid pattern onto the surface of 3D object 10, and then distortions in the projected grid pattern are visible on the surface of 3D object 10 and captured by 3D camera 20. The grid pattern can have different colors to aid contour identification. A time-varying sinusoidal pattern can a Iso be projected onto 3D object 10 and variations captured by 3D camera 20 at different times. A second 3D camera 20′ may be used for stereoscopic image-capture methods, or 3D camera 20 or object 10 may be moved to capture views from different sides or angles that are later combined into a single 3D model for object 10. The 3D information can be stored as a contour map of Z or range data in addition to the normal 2D image information captured by a camera. Some standard 3D geometry-file formats exist such as DXF, VRML, and STL. Various proprietary formats may also be used.

With reference to FIG. 2B, 3D milling machine 24 may read the geometry file from the 3D camera 20 and mill a 3D shape of the captured object. Various rapid-prototyping systems are available, such as a Computer-Numeric-Control CNC milling machine. Milling machine 24 receives the geometry file captured by 3D camera 20 and converts the geometry file to a series of motions of a drill or lathe bit 22. A milling blank 28 may be loaded into milling machine 24 and can be moved up, down, left, right, and rotated by a turn-table 25 to allow bit 22 to cut at desired locations on milling blank 28. After some time, bit 22 has cut away portions of milling blank 28 to reveal the desired milled shape 26. Milled shape 26 is a representation of 3D object 10 that was captured by 3D camera 20 and described by the geometry file sent to milling machine 24. While milled shape 26 is a 3-dimensional representation of 3D object 10, it may lack color, texture, and other details of 3D object 10. For example, milling blank 28 may be a block of wax or soft plastic and may be of uniform color and texture. Then milled shape 26 has the same uniform color and does not have the same colors and textures as 3D object 10.

The color and texture details of 2D picture 18 (FIG. 1B) are lost in order to add the 3D details of milled shape 26. However, 2D picture 18 lacks the depth and shape of milled shape 26. Neither 2D picture 18 nor milled shape 26 satisfyingly copies the color, details, and shapes of 3D object 10.

FIG. 3 illustrates a conventional way of making a custom 3D figurine 39. After an image of an object 30 is captured by camera 31, a picture 34 may be printed by color printer 33 or developed from an application such as Photoshop available from Adobe Systems, Incorporated of San Jose, Calif., and shown as a digital image 32. A sculptor may use picture 34 as a basis to sculpt a sculpted object 35 featuring the face and head shown in picture 34. The sculpted object 35 may be sculpted from a soft clay. The completed sculpted object 35 may then go through a hardening process such as by placing it into a kiln or oven 36 to harden. Alternatively other resin materials that can be harden quickly may be used to sculpt the features shown in picture 34 to sculpted object 35. Further, porcelain materials may be used.

After the hardening process, a paint master may use the picture 34 or digital image 32 to paint additional features onto the sculpted object 35 including skin color facial hair. Following the painting process, a fully colored and hardened head 38 may be attached with a spring and later engaged to a body to comprise a figurine 39.

Sculpting a generic human face and head is simple because it does not have to resemble to any person. Custom sculpting an actual face of a person entails a high degree of difficulty, and is both costly and time consuming. Alternative prior art techniques include using a mask to mask the geometry of the face and casting a mold from the mask to build the face and head. This technique is limited in that once masked, the resulting mold cannot be scaled. This technique disadvantageously requires putting masking material on the subjects face and waiting for the masking material to dry before removing the mask

Another technique includes taking pictures at different angles to determine the depth, position, ratio and contour of varied parts of the face, eyes, nose, ears, mouth and head. However, all techniques using pictures to sculpt a human face and head are very error prone, time consuming, provide inconsistent quality and are costly.

U.S. Pat. No. 6,244,926 issued to George et al. provides a system and method for producing realistic doll heads that have the facial appearance of particular children. The customer, using ten facial characteristics set forth in a chart, selects from among a predetermined number of facial characteristics those most closely resembling the facial appearance of the child. The facial characteristics that are selected comprise seven face shapes; skin tone; eye color; eyelash color; eyebrow color, thickness, and shape; hair color, cut, length, and style; and birthmarks, moles, and/or freckles. The selected characteristics are then applied to the doll head to produce a one-of-a-kind doll closely resembling the child.

U.S. Pat. No. 4,993,987 issued to Hull et al. pertains to creating a doll having a personalized, photographic face such as a mother's face, impregnated in the material of which the doll is constructed. U.S. Pat. No. 5,926,388 relates to a system and method for producing a three dimensional relief. U.S. Pat. No. 6,549,819 relates to a method of producing a three-dimensional image.

In view of the foregoing disadvantages in the prior art, there is a need for a custom 3D figurine which provides for a realistic likeness to the subject being represented. Preferably such a 3D figurine is inexpensive and a method of producing such a 3D figurine requires little turn around time, provides consistent quality and a 3D figurine having realistic features including color, contour, and depth.

### SUMMARY OF THE INVENTION

In accordance with one aspect of the invention, a three dimensional head representative of a head of a three dimensional object includes a milled and sculpted head of the head of the three dimensional object having painted features thereon.

In accordance with another aspect of the invention, a method of making a three dimensional head representative of a head of a three dimensional object includes the steps of creating a geometric file of the head of the three dimensional object, creating an image file of the head of the three dimensional object, milling a milled head based upon the geometric file, recasting the milled head into a sculptable head, sculpting the sculptable shape, painting features onto the sculpted shape based upon the image file.

These and other features, aspects, and advantages of the present invention will become better understood with reference to the following drawings, description, and claims.

### BRIEF DESCRIPTION OF THE DRAWINGS

FIGS. 1A and 1B illustrate a prior art digital camera for capturing a 2D image and a computer and printer for displaying the 2D image.

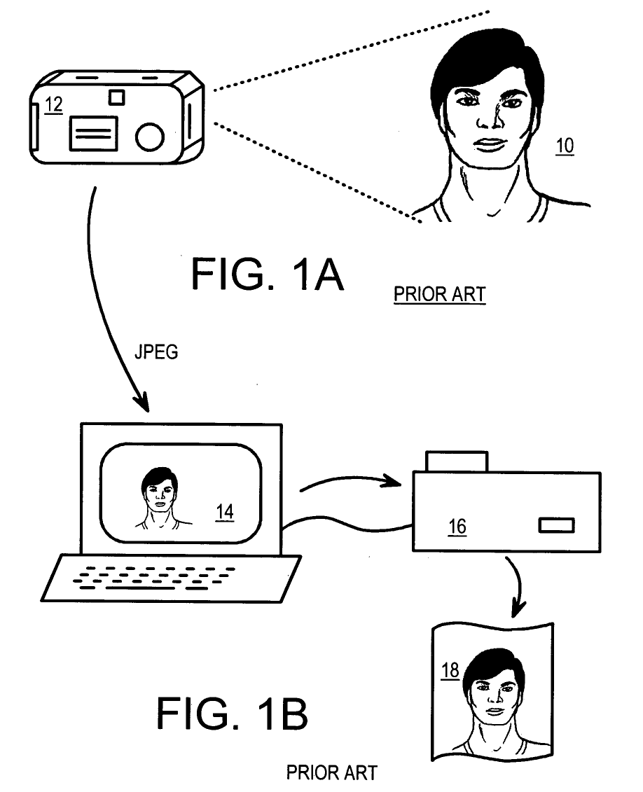

FIGS. 2A and 2B illustrate a prior art 3D camera and a 3D milling machine that generate a 3D replica.

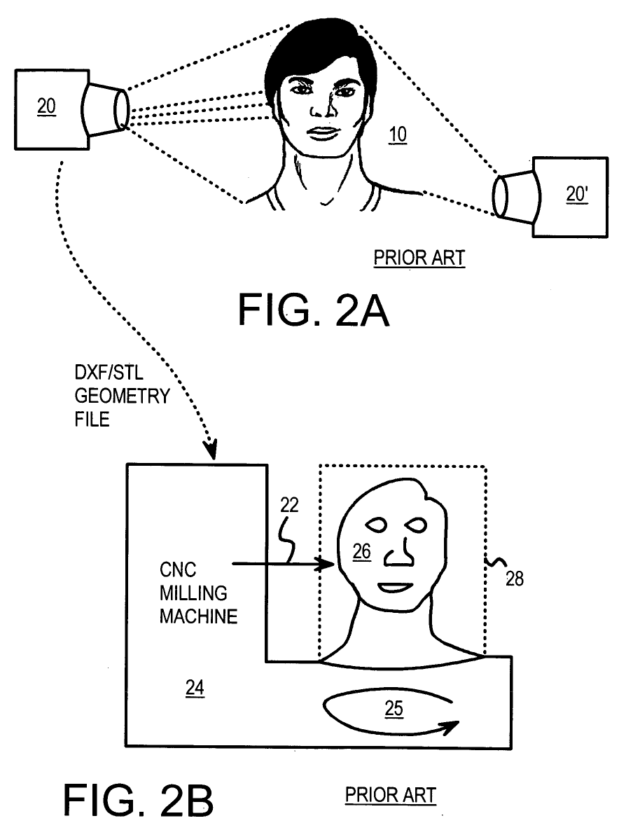

FIG. 3 illustrates a prior art process of a making a custom 3D figurine.

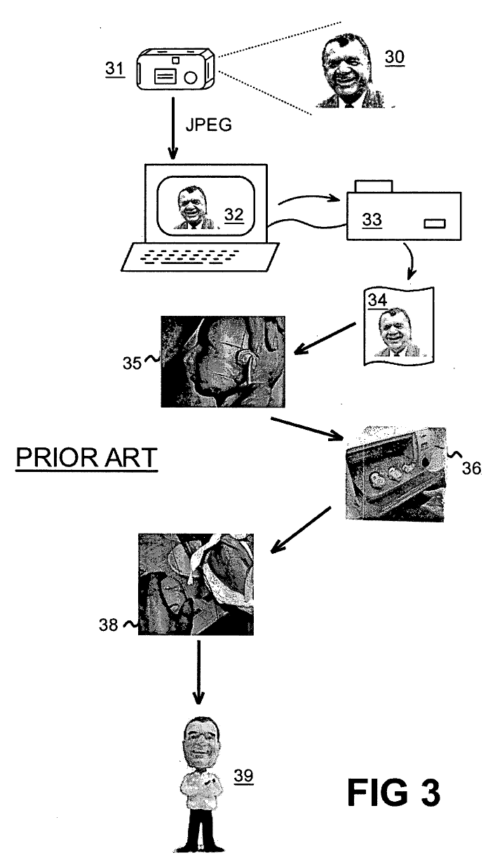

FIG. 4 is a diagram illustrating a process of making a 3D figurine in accordance with the present invention;

FIG. 5 is a flowchart illustrating the process of making a 3D figurine in accordance with the present invention; and

FIG. 6 is a flowchart illustrating a milling process in accordance with the present invention.

### DETAILED DESCRIPTION OF THE INVENTION

The present invention relates to a method of making custom 3D figurines. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

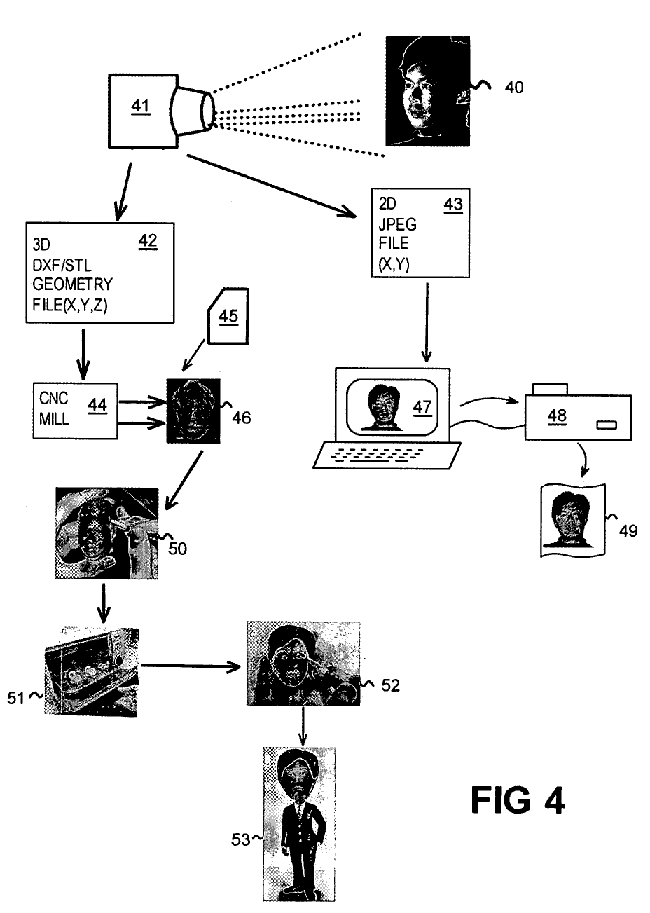

With reference to FIG. 4, a schematic representation of a method of making a custom 3D figurine is shown. Laser range-finding or other techniques may be used by a 3D camera 41 to capture geometric details of a 3D object 40. The geometric details captured by 3D camera 41 may be loaded into a geometry file 42 which may include a standard format file such as DXF, STL, VRML, and IGES. Geometry file 42 may contain three dimensional coordinate data representative of points on the surface of 3D object 40.

3D camera 41 may also be operable to capture a 2D image of object 40. In a preferred embodiment, the 2D image may be captured contemporaneously with the capture of geometric details of the 3D object 40 through a lens of 3D camera 41 in order to minimize distortions between the captured 2D image and the captured geometric details. In another embodiment, the laser range-finder may be slightly offset from a 2D image capturing lens.

The captured 2D image may be loaded into a JPEG 2D image file 43 or into a 2D image file having any other format such as a TIFF file. Color pixel data for 2D coordinate locations in the captured 2D image may be stored in 2D image file 43.

In this manner, 3D camera 41 outputs both geometry file 42 and 2D image file 43. Some commercially available 3D cameras are capable of outputting both files 42, 43, such as the VIVID 700 available from Konica Minolta of Tokyo, Japan.

Geometry file 42 may be sent to a 3D milling machine 44 which may be a computer-numerical-controlled (CNC) machine such as a computer-controlled lathe, mill, and drill. Geometry file 42 may first be processed and converted by a computer to generate machine-instruction files that may control the positioning of a cutting bit and work piece on milling machine 44. A milling blank 45 may comprise wax or a soft plastic material that can be shaped by milling machine 44. Milling blank 45 may be loaded onto milling machine 44 and shaped to generate a custom milled shape 46 which has the shape of 3D object 40 described by geometry file 42.

The 2D image file 43 may be sent to a personal computer (PC) 47. PC 47 may generate a printer file of the 2D image file 43 that may be sent to a printer 48. Printer 48 may generate a printed 2D image sheet 49 which has printed on it the 2D image captured by 3D camera 41 as 2D image file 43. Both printed 2D image sheet 49 and custom milled shape 46 may be custom representations of 3D object 40.

Custom milled shape 46 may be re-cast into sculptable material such as clay to refine features such as a face, eyes, nose, mouth and ears and to create a sculptable head 50. If only the face is captured by 3D camera 41 instead of the whole head, a sculptor may build a back side of the head and merge the back side with the face re-cast from custom milled shape 46 to complete the sculptable head 50.

The sculptable head 50 may go through a hardening process such as by placing the sculptable head 50 in a kiln or oven to create a hardened head 51. Alternatively, the sculptable head 50 may be re-cast with a self-hardening material such as a resin material to create the hardened head 51.

A paint master or artist may use the printed 2D image sheet 49 or the 2D image from a monitor of PC 47 to paint flesh tones of the face, eyes, eyebrows, lips, teeth and hair onto the hardened head 51 to create a figurine head 52.

The figurine head 52 may be attached to a body with or without a spring to complete a custom 3D figurine 53.

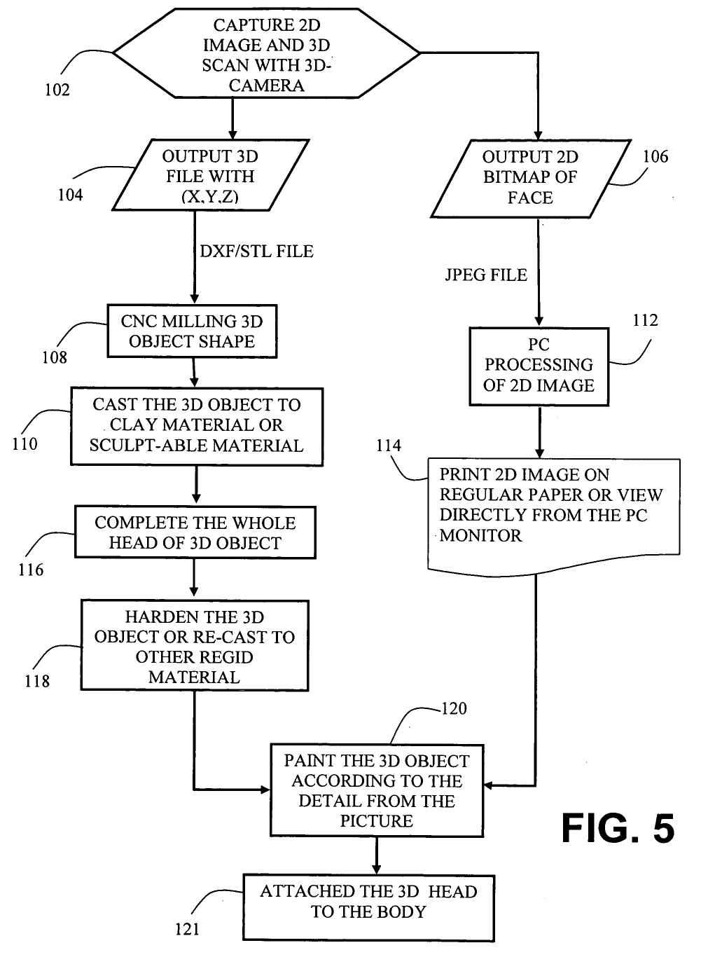

With reference to FIG. 5, a method of forming the custom 3D figurine 53 is shown. In a step 102, a 3D camera may capture both a 2D image and 3D geometric details of a 3D object. Some scanning may be performed to determine the geometric details, such as scanning by a laser range-finder or processing of fringe diffraction patterns of a projection on the 3D object. Two files may be generated by the 3D camera; a geometry file indicating 3D coordinate data and a 2D image file indicating 2D coordinate color data. The geometry file is typically coordinate data that corresponds to an industry standard such as DXF of AutoCAD, IGES, or STL format. The geometry file may be mono-color (black and white or grayscale) while 2D image file contains color information.

The geometry file may be output by 3D camera in a step 104. In a step 108 a CNC milling machine may machine a custom milled shape. Some pre-processing may be performed by the CNC machine itself or by another computer, such as converting a DXF/STL format of the geometry file into a file of machine-control instructions or Numerical Control format (NC). The custom milled shape may represent the object described by the geometry file.

In a step 110 the custom milled shape may be re-molded and re-cast into a sculptable shape. The sculptable shape may be formed of a clay material or a resin material. Next in a step 116 a sculptor may sculpt features onto the sculptable shape to complete a sculptable head.

The sculptable head may be hardened in a step 118 to create a hardened head. Such hardening may include placing the sculptable head into a kiln or oven. Alternatively, a sculptable head formed of resin may self-harden.

In a step 106, the 2D image file may be sent to a personal computer or workstation. The 2D image file may have a standard format such as JPEG, BMP, and TIFF. The personal computer may processes the 2D image file in a step 112, such as by generating a printer file. The processed 2D image file may be printed by a printer in a step 114.

A paint master may paint the hardened head based upon the printed 2D image file to resemble the eyes, eye color, eyebrows, flesh tones, and the lips of the 3D object in a step 120 to create a figurine head. Finally, in a step 121, the figurine head may be attached to a body with or without a spring to complete the custom 3D figurine.

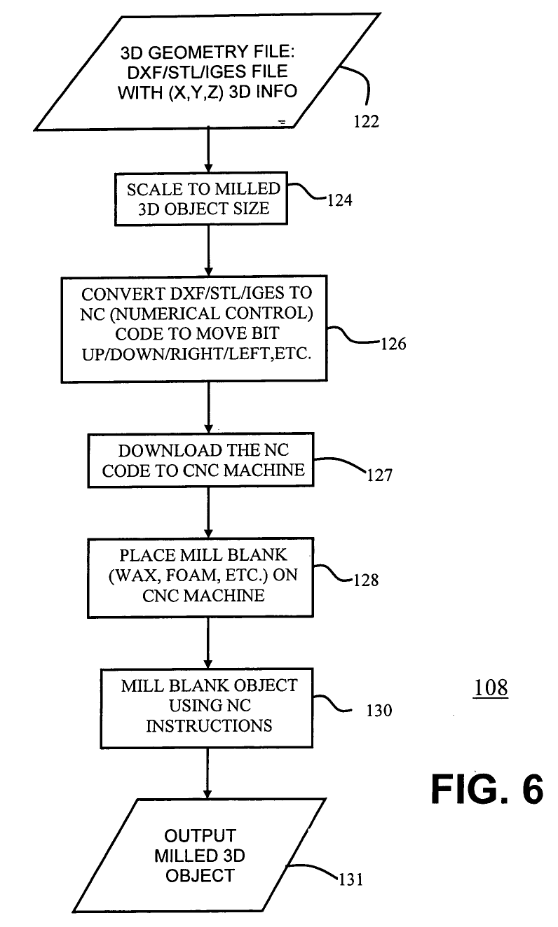

With reference to FIG. 6, a more detailed flowchart of CNC milling step 108 is shown. In a step 122, the CNC milling machine may receive the DXF/STL geometry file. The size of the 3D object may be scaled in a step 124 to fit the shape and size of a milling blank. In a step 126, the geometry file may be compiled into machine instructions or industry NC numerical-code files which control movement and operation of cutting instruments of the CNC milling machine. In a step 127, the converted NC code files may be downloaded into the CNC milling machine.

The milling blank is placed on the CNC machine in a step 128. The milling blank may be wood, plastic, wax, foam, or other millable material that can be cut by the CNC milling machine. The converted geometry file of machine instructions is then executed by the CNC milling machine causing the milling machine to cut the milling blank according to the instructions in a step 130. The milling machine may pause part-way through the program to allow a human operator to change cutting instruments or flip over the partially-milled blank. The final milled 3D object can be removed once execution is complete in a step 131.

### Alternate Embodiments

Several alternative embodiments are contemplated by the inventor. It is possible to capture a 3D human face only or a whole head from different angles to build the custom 3D figurine. Capturing the whole head requires milling the front face and back head separately. Some CNC machines include a rotary axis that can mill the whole head without milling the front and back of the head separately. 3D printer from Z. Corporation of Burlington, Mass. can be used instead of a CNC milling machine.

There are a variety of means for attaching the figurine head to the body. For example, a magnet may be attached inside the center the figurine head and a metal piece may be attached on the body's upper neck to allow the figurine head to easily snap onto the body and also allow the same figurine head to be easily attached to different type of body.

The custom 3D figurines of the present invention and the method of making the custom 3D figurines of the present invention overcome the deficiencies of the prior art by providing for a realistic likeness to the subject being represented. The custom 3D figurine described is inexpensive and the method of producing the custom 3D figurine requires little turn around time, provides consistent quality and a custom 3D figurine having realistic features including color, contour, and depth.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. A three dimensional head representative of a head of a three dimensional object comprising:
a milled and sculpted head of the head of the three dimensional object having painted features thereon.

2. The three dimensional head of claim 1, wherein the milled and sculpted head is scaled.

3. The three dimensional head of claim 1, wherein the milled and sculpted head is milled using a geometry file generated by a 3D camera.

4. The three dimensional head of claim 1, wherein the painted features are based upon an image captured by a camera.

5. The three dimensional head of claim 1, wherein the milled and sculpted head is formed of hardened clay.

6. The three dimensional head of claim 1, wherein the milled and sculpted head is formed of a resin material.

7. The three dimensional head of claim 1, wherein the milled and sculpted head is formed of a porcelain material.

8. The three dimensional head of claim 1, wherein the milled and sculpted head is formed of self-hardening material.

9. A method of making a three dimensional head representative of a head of a three dimensional object comprising the steps of:
creating a geometric file of the head of the three dimensional object;
creating an image file of the head of the three dimensional object;
milling a milled head based upon the geometric file;
recasting the milled head into a sculptable head;
sculpting the sculptable shape;
painting features onto the sculpted shape based upon the image file.

10. The method of making a three dimensional head representative of a head of a three dimensional object of claim 9, wherein the geometric file and the image file are created by a 3D camera.

11. The method of making a three dimensional head representative of a head of a three dimensional object of claim 9, wherein the geometric file and the image file are created by a same camera.

12. The method of making a three dimensional head representative of a head of a three dimensional object of claim 9, wherein the sculptable head is formed of clay and the clay is hardened in a hardening step.

13. The method of making a three dimensional head representative of a head of a three dimensional object of claim 9, wherein the sculptable head is formed of a self-hardening material.

14. The method of making a three dimensional head representative of a head of a three dimensional object of claim 9, wherein the sculptable head is formed of resin.

15. The method of making a three dimensional head representative of a head of a three dimensional object of claim 9, wherein the sculptable head is formed of porcelain.

16. A three dimensional representation of an object comprising:
a scaled, milled and sculpted object having painted features thereon, the object being milled using a geometry file generated by a 3D camera.

17. The three dimensional representation of claim 16, wherein the painted features are based upon an image captured by a camera.

18. The three dimensional representation of claim 16, wherein the milled and sculpted head is formed of hardened clay.

19. The three dimensional representation of claim 16, wherein the object is milled by a CNC machine.

20. The three dimensional representation of claim 16, wherein the object is milled by a 3D printer.
